(19) United States
(12) Patent Application Publication
(10) Pub. No.: US 2015/0137726 A1
(43) Pub. Date: May 21, 2015

(54) MOTOR CONTROLLER FOR PROTECTING TOOL AND OBJECT TO BE PROCESSED IN EMERGENCY STOP

(71) Applicant: FANUC CORPORATION, Yamanashi (JP)

(72) Inventor: Zhiwei Tang, Yamanashi (JP)

(21) Appl. No.: 14/540,225

(22) Filed: Nov. 13, 2014

(30) Foreign Application Priority Data
Nov. 15, 2013 (JP) 2013-237220

(51) Int. Cl. G05B 19/4061

(52) U.S. Cl. CPC G05B 19/4061
USPC 318/563

(57) ABSTRACT

A motor controller according to the present invention includes a stop cause detecting unit for detecting a stop cause by which an emergency stop of a motor is carried out, a stop command generating unit for generating a stop command that stops a tool along a command trajectory, and a retraction command generating unit for generating a retraction command that moves the tool and an object to be processed relatively with each other so that interference between the tool and the object to be processed is avoided. The motor controller is configured such that a machine tool is operated according to a superimposed command obtained by superimposing the retraction command onto the stop command when the stop cause detecting unit detects a stop cause.

### BACKGROUND

1. Technical Field

The present invention relates to a motor controller controlling a motor that drives a movable axis of a machine tool.

2. Description of Related Art

FIG. 9 is a schematic diagram depicting a tool T of a machine tool and a workpiece W to be processed by the machine tool. The tool T is attached to a main spindle S of a three-axis vertical machining center and used to process the workpiece W. The machine tool has movable axes capable of moving independently of each other along X-axis, Y-axis and Z-axis. For example, when the machine tool is controlled so as to follow the contour of a surface W1 of the workpiece W, the main spindle S is moved along the Z-axis in a vertically upward and downward direction, while moving on a horizontal plane defined by the X-axis and Y-axis. In this manner, processing of the workpiece W is continuously performed by moving the tool T along the surface W1 of the workpiece W.

When a power failure occurs during the processing of the workpiece W and power supply to the machine tool is shut down, a brake device usually operates to stop a vertically downward movement of the tool T due to gravity. However, sometimes, the tool T deviates from a command trajectory and moves toward the workpiece W in the period between the occurrence of the power failure and the stopping of the tool T by the operation of the brake device, as a result of which the tool T may damage the workpiece W. Alternatively, the tool T may contact the workpiece W from an unexpected angle, thereby being damaged. Thus, a controller has been proposed that is configured to execute a retracting operation that separates a tool T from a workpiece W before a machine tool stops.

JP-A-2003-131701 discloses a servo-motor driven machine in which a servo controller is configured to give a servomotor an operation command elevating a movable axis by a predetermined amount not less than an amount of backlash of a brake device in an emergency stop or the like. This technique is intended to prevent collision and interference between the movable axis and a surrounding object such as a workpiece upon descent of the movable axis due to the backlash of the brake device.

In addition, JP-A-2008-204365 discloses a machine tool that causes a movable body of each control axis in horizontal and vertical directions to decelerate and stop in order to retract a tool to a safe position when power supply is shut down due to power failure or the like.

However, in the servo controller disclosed in JP-A-2003-131701, the movable axis is retracted simply in such a manner as to elevate the axis, which thus may not always lead to the protection of a processed surface of the workpiece. In the servo motor controller disclosed in JP-A-2008-204365, the tool is decelerated and stopped once and then separated from the object to be processed, so that the object to be processed may be damaged in a time period before the machine tool stops.

Accordingly, a motor driver has been desired that can stop the operation of a machine tool without damaging a tool and an object to be processed in an emergency, such as power failure.

### SUMMARY OF THE INVENTION

According to a first invention of the present application, there is provided a motor controller for controlling a motor that drives a machine tool, the motor controller including: a stop cause detecting unit for detecting a stop cause by which an emergency stop of the motor is carried out; a stop command generating unit for generating a stop command that stops a tool along a command trajectory; and a retraction command generating unit for generating a retraction command that moves the tool and an object to be processed relatively with each other so that interference between the tool and the object to be processed is avoided, the motor controller being configured such that the machine tool is operated according to a superimposed command obtained by superimposing the retraction command onto the stop command when the stop cause detecting unit detects the stop cause.

According to a second invention of the present application, in the motor controller according to the first invention, the retraction command is adjusted based on a predetermined retraction amount and a predetermined retraction time.

According to a third invention of the present application, in the motor controller according to the second invention, the retraction command is adjusted by a low pass filter having a cut-off frequency determined according to the retraction amount and the retraction time.

According to a fourth invention of the present application, in the motor controller according to the second invention, the retraction command is adjusted such that the tool is moved according to a constant speed obtained by dividing the retraction amount by the retraction time.

According to a fifth invention of the present application, in the motor controller according to any of the first to the fourth inventions, the motor controller is configured to switch between an effective state in which the retraction command generating unit generates the retraction command and an ineffective state in which the retraction command generating unit does not generate the retraction command.

According to a sixth invention of the present application, in the motor controller according to any of the first to the fifth inventions, a direction of retracting operation of the tool designated by the retraction command is determined according to a positional relationship between the tool and the object to be processed.

The foregoing and other objects, features, and advantages of the present invention will be more fully understood based on the following detailed description of exemplary embodiments of the invention illustrated in the accompanying drawings.

### BRIEF DESCRIPTION OF THE DRAWINGS

FIG. 1 is a functional block diagram depicting a motor controller according to a first embodiment of the present invention;

FIG. 2 is a view for explaining a retraction command and a stop command generated according to an embodiment of the invention;

FIG. 3 is a view for explaining a retraction command and a stop command generated according to an embodiment of the invention;

FIG. 4A is a view depicting an example of a retraction command generated according to an embodiment of the invention;

FIG. 4B is a view depicting an example of a retraction command generated according to an embodiment of the invention;

FIG. 4C is a view depicting an example of a retraction command generated according to an embodiment of the invention;

FIG. 5 is a flowchart depicting a flow of processing executed according to the first embodiment of the invention;

FIG. 6 is a functional block diagram depicting a motor controller according to a second embodiment of the invention;

FIG. 7A is a view depicting an example of a positional relationship between a tool and an object to be processed;

FIG. 7B is a view depicting an example of a positional relationship between a tool and an object to be processed;

FIG. 8 is a flowchart depicting a flow of processing executed according to the second embodiment of the invention; and

FIG. 9 is a schematic diagram depicting a tool of a machine tool and an object to be processed.

### DETAILED DESCRIPTION OF THE INVENTION

Hereinafter, embodiments of the present invention will be described with reference to the accompanying drawings. Constituent elements of the embodiments depicted in the drawings may be modified in scale as necessary for easier understanding of the invention.

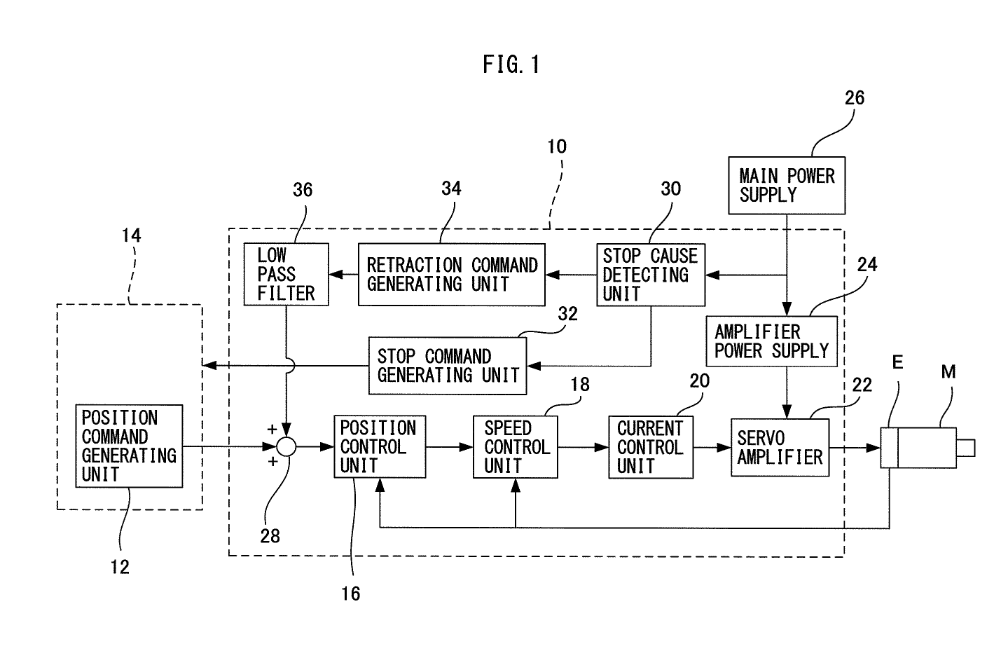

FIG. 1 is a functional block diagram depicting a motor controller 10 according to a first embodiment of the present invention. The motor controller 10 is configured to control operation of a motor M in collaboration with an upper controller 14 provided with a position command generating unit 12. The motor M is provided with an encoder E so that information relating to an operational state of the motor M, such as a rotational position and a rotational speed of the motor M can be obtained. As depicted in the drawing, the motor controller 10 includes a position control unit 16, a speed control unit 18, a current control unit 20, a servo amplifier 22, an amplifier power supply 24, a stop cause detecting unit 30, a stop command generating unit 32, a retraction command generating unit 34, and a low pass filter 36.

The upper controller 14 and the motor controller 10 have a known hardware structure including a ROM capable of storing a program, a CPU executing various kinds of arithmetic operation processing according to the program, a RAM temporarily storing arithmetic operation results, input means (for example, a mouse and a keyboard), a display means (for example, a liquid crystal display), and an interface for transmitting a signal to and receiving a signal from an external apparatus, the motor M and the like.

The upper controller 14 includes the position command generating unit 12 that generates a position command for the motor M according to a predetermined processing program. The position command is generated in a known manner based on the processing program, processing conditions such as a tool feeding speed, and other various parameters.

The position control unit 16 generates a speed command based on an amount of positional deviation between the position command generated by the position command generating unit 12 and a positional feedback of the motor M output from the encoder E. The speed control unit 18 generates a torque command based on an amount of speed deviation between the speed command output from the position control unit 16 and a speed feedback of the motor M output from the encoder E. The current control unit 20 generates a current command in accordance with the torque command output from the speed control unit 18. Then, according to the current command output from the current control unit 20, electric current driving the motor M is supplied to the motor M through the serve amplifier 22. Structures and functions of the position command generating unit 12, the position control unit 16, the speed control unit 18, the current control unit 20, and the servo amplifier 22 are known and thus more detailed explanations thereof are omitted in the present specification.

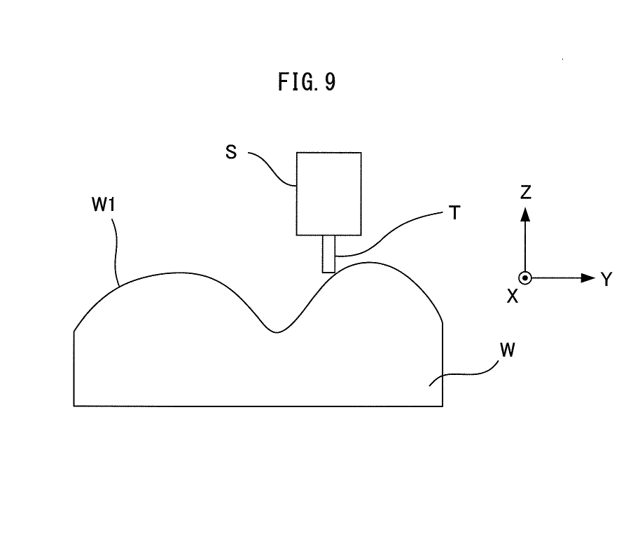

The motor M can be used, for example, in a three-axis vertical machining center as described above with reference to FIG. 9. However, the application of the motor M is not limited thereto, and the motor M may be used in a known arbitrary type machining tool to drive a movable axis of the machining tool. For simpler explanation, a machine tool in which a tool is moved by the motor M is mainly described herein. However, a person skilled in the art should note that the present invention can be similarly applicable to machine tools in which an object to be processed is moved by the motor M and those in which a tool and an object to be processed can both be moved by the motor M. In other words, either or both a tool and an object to be processed can be a movable body as long as the tool and the object to be processed are relatively movable with respect to each other.

The amplifier power supply 24 supplies electric power to the serve amplifier 22 from a main power supply 26 supplying electric power to a control system of a machine tool. The amplifier power supply 24 may include a power storage means such as a capacitor. When the amplifier power supply 24 includes the power storage means, the amplifier power supply 24 can be configured to supply electric power necessary to execute a retracting operation of a tool T that will be described below, to the motor controller 10 when power supply from the main power supply 26 is shut down.

The stop cause detecting unit 30 is configured to detect a stop cause by which an emergency stop of a machine tool should be made. For example, the stop cause detecting unit 30 is configured to be able to detect the shutdown of power supply from the main power supply 26 when a power failure occurs. The present invention is also applicable in the case of an emergency stop of a machine tool in response to a stop cause other than power failure. Accordingly, examples of the stop cause may include, besides power failure, the detection of an error signal and the operation of an emergency stop button by an operator.

The stop command generating unit 32 generates a stop command when the stop cause detecting unit 30 detects the occurrence of a stop cause. The generated stop command is output to the upper controller 14. The upper controller 14 outputs the stop command as a position command to an adding unit 28. The stop command is generated to stop the motor M at a constant deceleration along a command trajectory designated, for example, according to a processing program. In other words, due to the stop command generated by the stop command generating unit 32, the tool is moved according to the expected command trajectory, during which a moving speed of the tool is gradually reduced.

The retraction command generating unit 34 generates a retraction command when the stop cause detecting unit 30 detects an occurrence of a stop cause. The retraction command is input to the adding unit 28 through the low pass filter 36. In other words, when the stop cause is detected, each of the stop command and the retraction command is input to the adding unit 28. The adding unit 28 functions to output a superimposed command obtained by superimposing the stop command onto the retraction command, as a position command, to the position control unit 16.

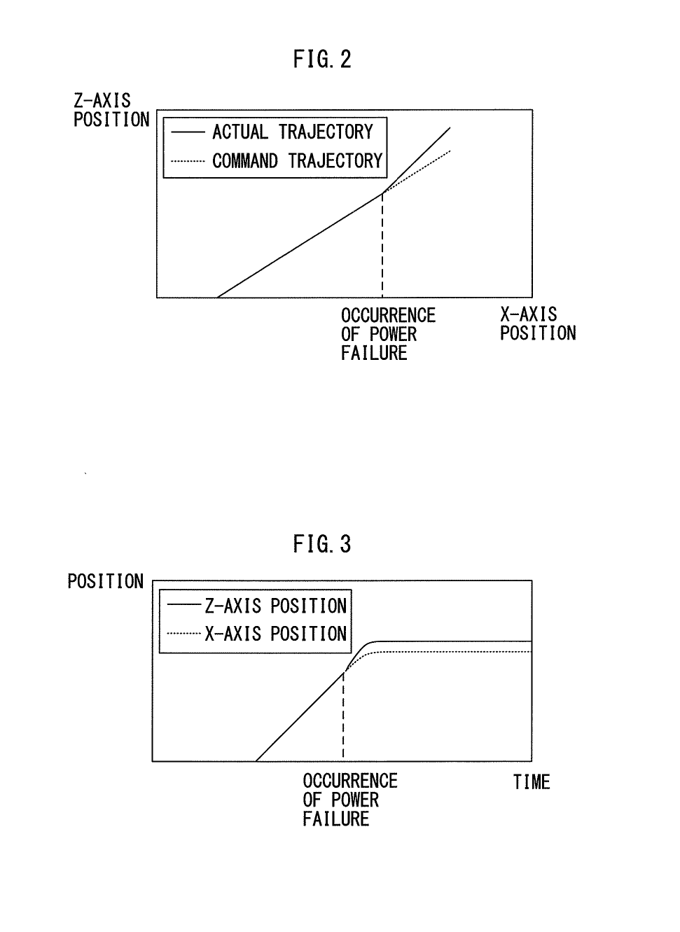

The retraction command causes the tool to move by a predetermined retraction amount in a direction apart from an object to be processed (such as a workpiece). FIGS. 2 and 3 are views for explaining a retraction command and a stop command. The horizontal axis of FIG. 2 represents an X-axis position of the tool and the vertical axis thereof represents a Z-axis position of the tool. The solid line of FIG. 2 represents an actual trajectory and the dotted line thereof represents a command trajectory. For simpler explanation, a Y-axis position of the tool is not taken into consideration here. However, it should be understood that the following explanation about the X-axis position also applies to the Y-axis position.

As described above, when a power failure occurs, the retraction command generating unit 34 adds a retraction command to the position command so that the tool is moved away from the object to be processed. As a result, the Z-axis position of the tool on the actual trajectory becomes greater than the command trajectory through which the tool is supposed to pass when no power failure occurs (in other words, the tool moves in a direction away from the object to be processed).

In FIG. 3, the horizontal axis represents time and the vertical axis represents the Z-axis position and X-axis position of the tool. The solid line of FIG. 3 represents a Z-axis position of the tool, and the dotted line thereof represents an X-axis position of the tool. For simpler explanation, in FIG. 3, the X-axis position and Z-axis position of the tool on the command trajectory are plotted so as to overlap with each other. When a power failure occurs, in response to a stop command, the tool is decelerated in the X-axis direction and stopped. On the other hand, in response to a retraction command in addition to the stop command, the tool is stopped at a Z-axis position greater than the command trajectory in the Z-axis direction (in other words, at a position away from the object to be processed).

Similarly, for simpler explanation, the embodiment in which the Z-axis direction corresponds to the retraction direction has been described. However, the present invention is not limited to such a specific embodiment. The retraction direction is determined according to a positional relationship between the tool and the object to be processed at the time of detection of a stop cause. Accordingly, the retraction direction is not limited to a direction along the Z-axis as described above and may be determined along any direction. The retraction direction may be, for example, a direction perpendicular to a processed surface of a workpiece.

The retraction direction can be determined in various ways. For example, the positional relationship between the tool and the object to be processed is obtained according to information on the length and posture of the tool and the shape of the object to be processed or information based on the command trajectory. Alternatively, the positional relationship between the tool and the object to be processed is detected by a visual sensor, and based on the detected information, the retraction direction may be determined.

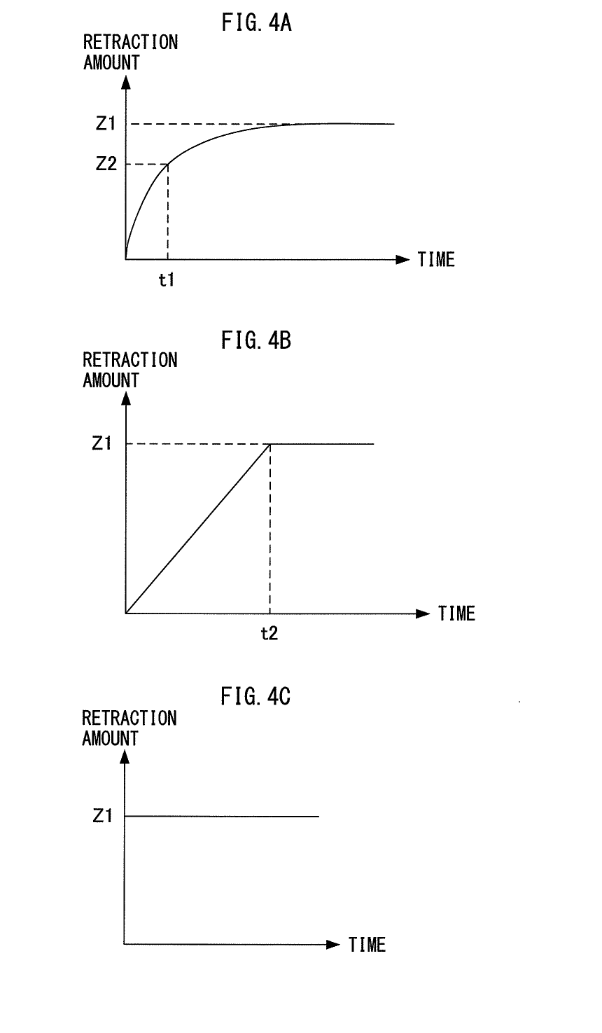

The low pass filter 36 eliminates a high frequency component included in the retraction command to alleviate a rapid change in a start-up phase of retracting operation of the motor. A cut-off frequency of the low pass filter 36 is calculated, for example, based on a predetermined retraction amount and a predetermined retraction time. FIG. 4A is a view depicting an example of a retraction command generated according to an embodiment of the present invention. In the retraction command depicted in FIG. 4, by the low pass filter 36, a rapid change in the start-up phase is alleviated. In this case, the retraction command is generated so that, the retraction amount gradually increases based on a predetermined retraction amount Z1 and a predetermined time constant t1, allowing the retracting operation of the motor to be smoothly carried out. A retraction amount Z2 represents a reaction amount corresponding to the time constant t1.

The low pass filter 36 may be, for example, a primary low pass filter represented by a formula below:

y(n)=x(n)+(1−K)×y(n−1)

In the formula, “y(n)” represents an output from the filter, “x(n)” represents an input to the filter, and “K” represents a filter coefficient.

In addition, a formula below holds when a start-up time constant is “t1”.

t1=−Ts/(ln K)

In the formula, “Ts” represents a sampling time, and “ln K” represents a natural logarithm of “K”.

FIG. 4B is a view depicting an example of a retraction command generated according to another embodiment of the invention. In this case, a rapid change in the start-up phase of the retracting command is alleviated based on a predetermined retraction amount Z1 and a predetermined retraction time t2. Specifically, in the example of FIG. 4B, the retraction command is generated according to a constant retraction speed obtained by dividing the predetermined retraction amount Z1 by the retraction time t2.

FIG. 4C is a view depicting an example of a retraction command generated according to another embodiment of the invention. In this embodiment, the retraction command is input stepwise to the adding unit 28, without using the low pass filter as described above. The retraction command may be generated according to any of the examples of FIGS. 4A to 4C or a retraction command may be employed in which a rapid change in a start-up phase of retracting command is alleviated in other known ways.

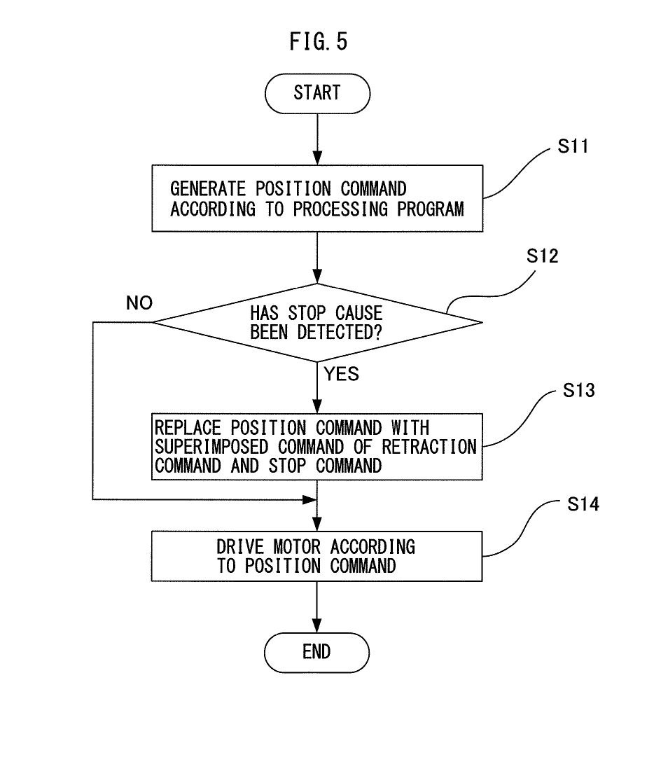

Next, an operation of the motor controller 10 will be described with reference to FIG. 5. FIG. 5 is a flowchart illustrating a flow of processing executed according to an embodiment of the invention.

In the driving control of the motor, the position command generating unit 12 of the upper controller 14 generates a position command according to a processing program, as described above (Step S11). In a normal operation (in other words, there is no stop cause), the motor controller 10 sequentially generates a speed command, a torque command, and a current command according to a position command input based on the processing program to drive the motor. Specifically, when no stop cause is detected in a step S12, the processing proceeds to a step S14, in which an expected processing treatment is executed. Then, the steps S11 to S14 are repeated until the processing treatment for a workpiece is completed.

On the other hand, when a stop cause is detected in the step S12, the processing proceeds to a step S13. In the step S13, the stop command generating unit 32 generates a stop command, and the retraction command generating unit 34 generates a retraction command. Then, a superimposed command obtained by superimposing the stop command onto the retraction command is input as a position command to the motor controller 10 (Step S13). Next, the processing proceeds to the step S14, in which the motor is driven according to the superimposed command, whereby the tool moves along a command trajectory while decelerating, and is retracted so as to be moved away from the object to be processed. When the stop cause is a power failure, the step S13 and the retracting operation and the stop operation of the step S14 following the step S13 may be executed using an auxiliary power supply (not shown) independent of the main power supply 26. Alternatively, the retracting operation and the stop operation may be executed by the power storage means incorporated in the amplifier power supply 24, as described above.

As described above, by a retraction command for retracting the tool in the direction away from the object to be processed, the interference or collision of the tool with the object to be processed and then the resulting damage to the tool or the object to be processed can be prevented. At the same time, the tool is stopped while being moved according to the command trajectory with respect to a processed surface of the object to be processed, so that quality of the processed surface is not impaired. As a result, when the stop cause is eliminated, such as when a power supply is restored, the tool can return to a processing position immediately before the stoppage and can quickly restart the processing treatment. This is particularly advantageous when power failure and power restoration are repeated in a short time.

Next, another embodiment of the invention will be described. In the following description, explanation of matters overlapping with the contents already described is omitted as necessary. In addition, identical or corresponding constituent elements have the same reference numerals.

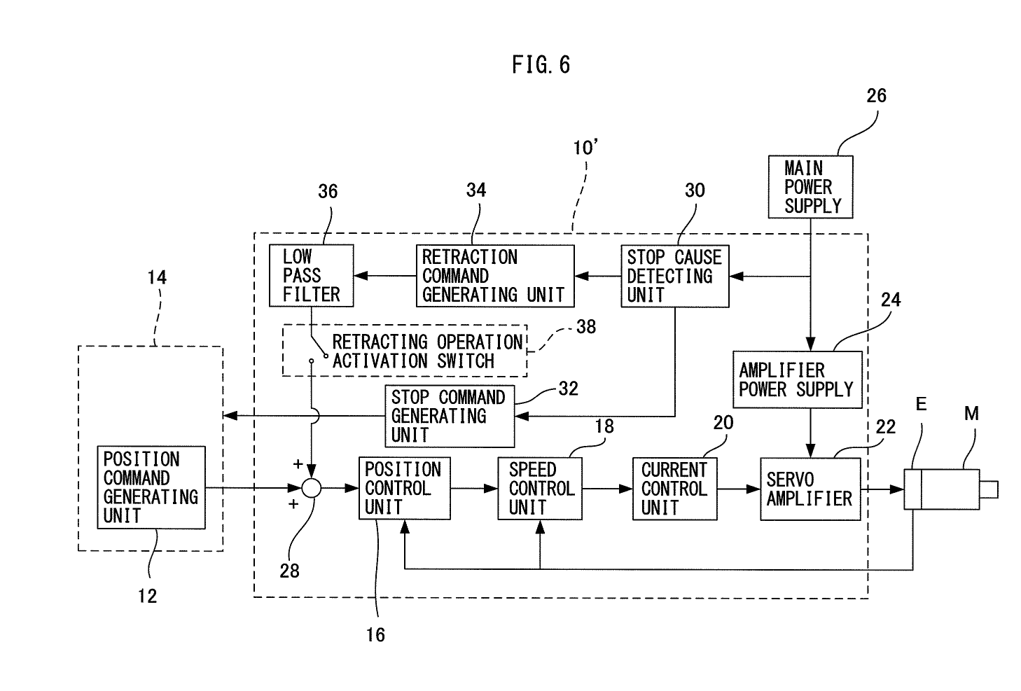

FIG. 6 is a functional block diagram depicting a motor controller 10′ according to a second embodiment of the invention. The motor controller 10′ according to the present embodiment further includes a retracting operation activation switch 38, in addition to the constituent elements of the motor controller 10 according to the first embodiment described above with reference to FIG. 1.

The retracting operation activation switch 38 is used to switch between an effective state in which a function of retracting operation of the motor is effective and an ineffective state in which the function is ineffective. The execution of retracting operation may sometimes be undesirable for a machine tool configured to retract a tool in a predetermined direction.

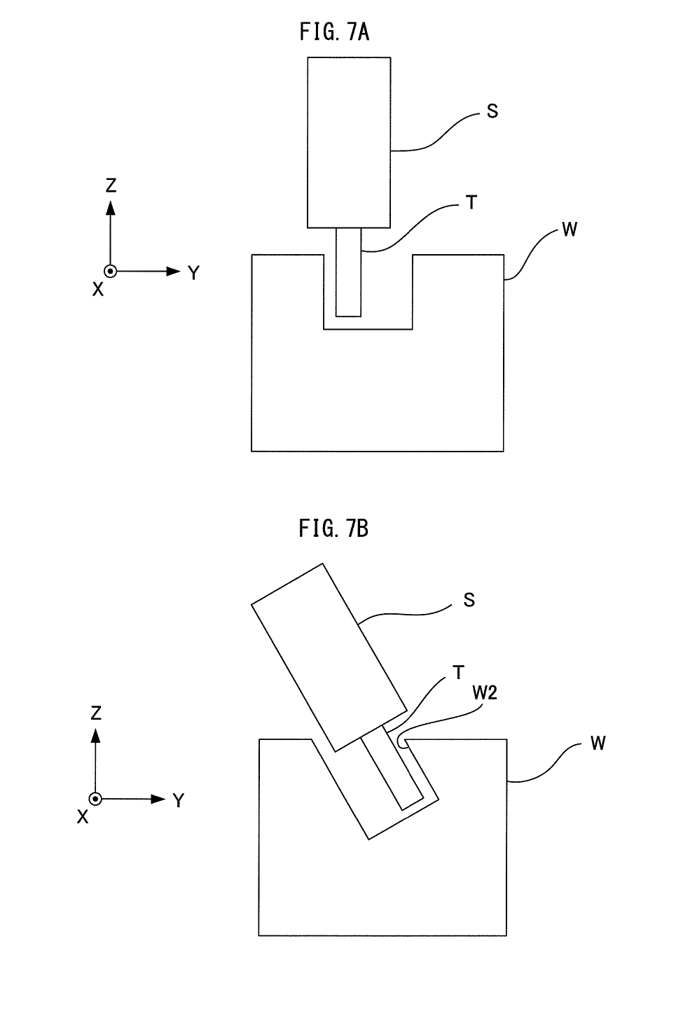

FIGS. 7A and 7B are views depicting a positional relationship between a tool T and a workpiece W (an object to be processed). In a state depicted in FIG. 7A, the tool T can be moved away from the workpiece W without interference with the workpiece W by moving a main spindle S in a Z-axis direction. On the other hand, in a state depicted in FIG. 7B, when the main spindle S is moved in the Z-axis direction, the tool T comes into contact with a processed surface W2 of the workpiece W.

As described in relation to FIG. 7B, when the retracting operation can rather cause interference between the tool T and the workpiece W, the retracting operation activation switch 38 is turned off to avoid the retracting operation from being carried out. Without execution of the retracting operation, the motor is stopped according to the stop command generated by the stop command generating unit 32 but the retracting operation in the Z-axis direction is not executed. Alternatively, instead of the stop command by which the motor is decelerated along the command trajectory, the motor may be simply stopped as soon as possible.

Whether the retracting operation should be effective or not is determined in various manners. For example, the motor controller 10′ may be configured to automatically switch on and off of the retracting operation activation switch 38, based on the shape information or position and posture information of the tool T and the workpiece W. Alternatively, the motor controller 10′ may be configured to receive an external signal for turning off the retracting operation activation switch 38, for example, based on detected information obtained by a visual sensor. Alternatively, the retracting operation activation switch 38 may be configured to be manually turned off by an operator. Alternatively, information which makes the retracting operation ineffective may be incorporated in advance in the processing program, so that the retracting operation activation switch 38 can be turned off upon execution of at least a part of the processing.

In addition, in some cases, the retracting operation should be ineffective for safety reasons. For example, when a worker accidentally enters a processing area, it is necessary to immediately stop the machine tool. In such a case, the machine tool may be quickly stopped without executing the retracting operation of the tool and the decelerating operation thereof along a command trajectory.

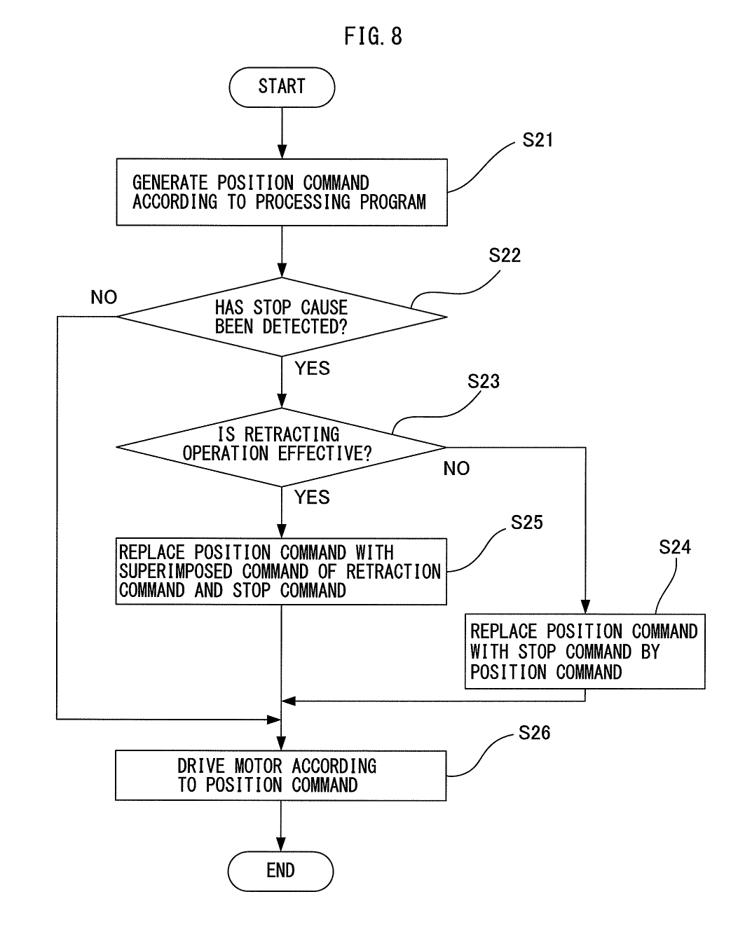

FIG. 8 is a flowchart depicting a flow of processing executed according to the second embodiment of the invention. Processing in steps S21, S22, S25, and S26 are the same as that in the steps S11 to S14 in the first embodiment described with reference to FIG. 5. Thus, explanations thereof are omitted.

In the present embodiment, in the step S23, it is judged whether the retracting operation is effective or not. When it is judged that the retracting operation should not be effective, the retracting operation activation switch 38 is switched off. Accordingly, even when a power failure is detected (even when the result of the judgment in the step S22 is positive), the retracting operation is not executed. In other words, in this case, instead of a superimposed command containing a retraction command and a stop command, the stop command is replaced with a position command (step S24). Then, the motor is stopped according to the stop command (step S26).

According to the present embodiment, since the retracting operation is switched to be effective or ineffective as necessary, the motor can be appropriately controlled according to the situation.

### Effects of the Invention

According to the motor controller with the structure described above, a tool can be stopped along a command trajectory and at the same time, can be retracted away from an object to be processed. Therefore, the retracting operation is carried out without delay, and interference between the tool and the object to be processed can be prevented. In addition, the tool is stopped along the command trajectory simultaneously with the retracting operation. This can prevent a processed surface of the object to be processed from being damaged by the tool.

Although the various embodiments and modifications of the present invention have been described above, it is apparent to those skilled in the art that other embodiments and modifications may also provide the functions and effects intended by the invention. Particularly, one or more of the constituent elements of the embodiments and modifications described above may be eliminated or replaced or any known means may further be added, without departing from the scope of the invention. Additionally, it is apparent to those skilled in the art that the invention may also be performed by arbitrarily combining the features of the plurality of embodiments explicitly or implicitly disclosed in the present specification.

What is claimed is:

1. A motor controller for controlling a motor that drives a machine tool, the motor controller comprising:
a stop cause detecting unit for detecting a stop cause by which an emergency stop of the motor is carried out;
a stop command generating unit for generating a stop command that stops a tool along a command trajectory; and
a retraction command generating unit for generating a retraction command that moves the tool and an object to be processed relatively with each other so that interference between the tool and the object to be processed is avoided,
the motor controller being configured such that the machine tool is operated according to a superimposed command obtained by superimposing the retraction command onto the stop command when the stop cause detecting unit detects the stop cause.

2. The motor controller according to claim 1, wherein the retraction command is adjusted based on a predetermined retraction amount and a predetermined retraction time.

3. The motor controller according to claim 2, wherein the retraction command is adjusted by a low pass filter having a cut-off frequency determined according to the retraction amount and the retraction time.

4. The motor controller according to claim 2, wherein the retraction command is adjusted such that the tool is moved according to a constant speed obtained by dividing the retraction amount by the retraction time.

5. The motor controller according to claim 1, configured to switch between an effective state in which the retraction command generating unit generates the retraction command and an ineffective state in which the retraction command generating unit does not generate the retraction command.

6. The motor controller according to claim 1, wherein a direction of retracting operation of the tool designated by the retraction command is determined according to a positional relationship between the tool and the object to be processed.
